(19) United States
(12) Patent Application Publication
(10) Pub. No.: US 2014/0267598 A1
(43) Pub. Date: Sep. 18, 2014

(54) APPARATUS AND METHOD FOR HOLOGRAPHIC POSTER DISPLAY

(71) Applicant: 360Brandvision, Inc., Las Vegas, NV (US)

(72) Inventors: Sylvio Drouin, San Francisco, CA (US); Olav Christensen, Brooklyn, NY (US)

(73) Assignee: 360Brandvision, Inc., Las Vegas, NV (US)

(21) Appl. No.: 14/281,300

(22) Filed: May 19, 2014

Related U.S. Application Data
(63) Continuation-in-part of application No. 13/927,785, filed on Jun. 26, 2013.
(60) Provisional application No. 61/836,902, filed on Jun. 19, 2013.
(60) Provisional application No. 61/836,797, filed on Jun. 19, 2013.
(60) Provisional application No. 61/825,270, filed on May 20, 2013.
(60) Provisional application No. 61/781,424, filed on Mar. 14, 2013.

(51) Int. Cl. G03H 1/00

(52) U.S. Cl. CPC G03H 1/0005; G03H 2001/0088; G03H 2001/0055
USPC 348/40

(57) ABSTRACT

The invention generally relates to holographic posters and computer controlled systems for communicating information. The invention provides a computer-based holographic poster device that displays holographic images and videos for interacting with interested users via, for example, their motions and gestures or their personal devices such as smartphones. A holographic poster device has a body such as a pedestal supporting a display area (e.g., a few feet above the floor) and is operable to make a holographic image appear in the display area.

### CROSS-REFERENCE TO RELATED APPLICATIONS

This application claims the benefit of and priority to U.S. Provisional Application No. 61/836,902, filed Jun. 19, 2013; U.S. Provisional Application No. 61/836,797, filed Jun. 19, 2013; and U.S. Provisional Application No. 61/825,270, filed May 20, 2013, the contents of each of which are incorporated by reference.

This application is a continuation-in-part of U.S. Non-Provisional application Ser. No. 13/927,785, filed Jun. 26, 2013, which claims priority to 61/781,424, filed Mar. 14, 2013, the contents of each of which are incorporated by reference.

### FIELD OF THE INVENTION

The invention generally relates to holographic posters and computer controlled systems for communicating information.

### BACKGROUND

People need information to help them satisfy their many needs and desires. Information is often provided in the form of advertisements such as posters, commercials, billboards, or movie previews. Some firms have sought to use electronic equipment with advertisements. See, for example, U.S. Pat. No. 8,418,387 to Swatt; U.S. Pat. No. 8,330,613 to Gothard; U.S. Pat. No. 8,116,081 to Crick; U.S. Pub. 2003/0105670 to Karakawa; U.S. Pub. 2002/0095334 to Kao; and U.S. Pub. 1213/0050060 to Ranger.

Unfortunately, despite advances with electronic components, much advertising apparently fails to engage any viewers. In fact, the very proliferation of video advertising in every location such as at gas pumps and in airport terminals may be causing more and more people to simply tune out those video clips that play repeatedly everywhere.

### SUMMARY

The invention provides a holographic poster device that displays holographic images and videos and that includes a computer with devices for interacting with interested users via, for example, their motions and gestures or their personal devices such as smartphones. A holographic image is displayed and can appear as a three-dimensional object or scene suspended in the air. The holographic poster can provide a unique and personalized interactive experience that is guided by local files in memory, content streaming from a server, the actions of a user, or a combination thereof. The poster device can display advertising information such as, for example, a movie poster at times, and can also provide interactive content such as interaction with digital characters through an avatar contained within the display and controlled by a smartphone or three dimensional characters and scenes that communicate with a person in response to that person's presence or actions. Due to the fact that the three dimensional scenes and characters appear in the air and can be directly influenced by passerby, the content will be naturally interesting and engaging to viewers. Viewers can indicate preferences for certain kinds of content through the use of electronic inputs. Also, due to the fact that content can adapt dynamically, instead of the repetition of a looped 2D video clip, people's minds will not be inclined to tune the content out. Additionally, since the delivery of content can be controlled automatically and on-the-fly by computer (i.e., showing a poster for a sequel just as a movie lets out; providing an interactive game when a sports fan approaches the device; or showing an ad related to a preference indicated via a smartphone), advertising media can be allocated just as-needed, giving efficient realization to advertising budgets. Advertising campaigns that deploy holographic posters of the invention will thus engage many viewers in dynamic, three-dimensional content, making the intended communication effective.

In certain aspects, the invention provides a holographic poster device that has a body supporting a display area and a computing device. The computing device includes a processor, a memory, and a display processing means (e.g., a video card connected via an expansion port on a motherboard or an integrated graphics chipset on a motherboard) and is operable to make a holographic image appear in the display area. The body may be in the form of a pedestal configured to sit on a floor with the display area at the top of the pedestal, preferably at least a few feet above the floor. The display area uses an electronic display source and a visible display area which can include, for example, a panel of at least partially reflective material disposed above the electronic display source at an angle with respect to the horizontal. In some embodiments, the material is a beam splitter at an angle between 35° and 65°. In certain embodiments, the display area uses an electronic panel disposed substantially horizontally when the pedestal is sitting on the floor, and a panel comprising an at least partially reflective material disposed at an angle above the electronic panel (e.g., between about 40° and about 50°).

The computing device operates to display images in the display area and may further include a network connection device such as a Wi-Fi card, Ethernet jack, or cellular modem. The device can use a wireless connection mechanism to exchange information with a handheld apparatus nearby such as the smartphone of a passerby.

In certain embodiments, the computing device is operable to stream images from a distal source while receiving a signal through the network connection device and display images from the memory while not receiving a signal through the network connection device.

A holographic poster may further include such features as stereo speakers, a touch-sensitive input device, a camera, others, or a combination thereof. The computer device can perform 3D processing such as z buffering on data captured by the camera. In some embodiments, the poster includes a graphics card comprising a RAM chip and a graphics processing unit.

In certain aspects, the invention provides a holographic poster that includes a pedestal to sit on a floor, a beam splitter disposed at an angle to the horizontal at the top of the pedestal, and an image source configured to cast an image onto the beam splitter. A computer device coupled to the image source provides display content. The image source may be a flat-panel monitor or other image generation means. The image source may be concealed from the view of a person standing near the poster. In certain embodiments, the beam splitter is at least about four feet above the floor. In general, the computer device includes a processor coupled to a memory and may include a graphics card that itself has a graphics processor. The computer device may be operable to receive the display content from a server computer and store the display content in memory therein. In some embodiments, the computer device is operable to exchange information with a mobile device nearby and control the display content according to user input received via the mobile device.

The holographic poster may further include a sensor to detect motion within a few feet of the device. The computer device can cause the display content to form a holographic video mimicking the detected motion, thus providing an interactive or user-controlled display.

The invention provides systems and methods for delivering content to and controlling holographic display devices. It has been found that holographic displays by holographic display devices have a captivating and engaging effect on many people, and the provided systems allow for delivery and control of packages of branding information including interactive content, games, videos, highlight reels, previews, social media interactions and other digital media synchronized among display devices and to extrinsic public events such as movie theaters and sporting events. The systems allow communicators (e.g., entertainers, advertisers, public service announcement entities) to control suites of display devices during and in synchrony with events, and also allows system administrators to control queuing and deliver among plural communicators. The systems further provide tools for end-user interaction such as downloadable mobile apps with which a user can turn their smartphone into a remote control or game controller to participate in a communicator's interactive content delivery.

In certain aspects, the invention provides a holographic display delivery system that uses a server computer with a memory coupled to a processor to receive content from at least one source, connect to a remote holographic display device, and transmit the content to the holographic display device. The system may then cause the holographic display device to display the content. The system may receive additional content and use a queue to cause the holographic display device to display the content and the additional content at specified times. In some embodiments, the queue comprises times of sporting events such as in-game event times or times of movie screenings (e.g., estimate times of theater entry and theater exit). Preferably, the system can be used to cause a plurality of holographic display devices to display the content. Preferably, the system can cause a synchronized series of displays on a set of holographic devices that are installed throughout a public event facility, wherein the synchronized series lasts for a duration of a public event.

In some embodiments, causing the holographic display device to display the content includes sending the content to holographic display device and disconnecting from the holographic display device prior to the display of the content by the holographic display device.

In certain embodiments, causing the holographic display device to display the content includes streaming the content directly from the server computer to a visual output mechanism on the holographic display device without storing the content in any persistent computer readable storage medium physically coupled to the holographic display device.

The system may be operable to aggregate the received content with additional content from a separate source to produce an aggregate video comprising the received content and the additional content, and to cause the holographic display device to display the aggregate video in 3D. Systems of the invention can register a user of the holographic display device, associate the user with a user account, and cause the holographic display device to display the content based on a user profile attribute. Further, a system may be used to receive an input from a user's use of a mobile device and to control the display of the holographic content according to the input. In some embodiments, the content comprises a game.

The system can be used to promote branding through direct displays and through contextual thematic immersion. For example, a system can re-skin the holographic display device by causing the display device to replace a first set of thematic elements visible in displays with a second set of thematic elements visible in the displays. In some embodiments, the first set and the second set of thematic elements comprise trademarks. The system may be used to re-skin a mobile app on a mobile device simultaneously with re-skinning the holographic display device and while the mobile device is interacting with the holographic display device.

In certain embodiments, the system provides a mobile app for download. Such a system may accept instructions from an installed version of the mobile app and control the display of the content according to the instructions.

In related aspects, the invention provides a holographic display delivery method that includes using a server computer comprising a tangible, non-transitory memory coupled to a processor for receiving content from at least one source, connecting to a remote holographic display device, transmitting the content to the holographic display device, and causing the holographic display device to display the content. The method may include receiving additional content and using a queue to cause the holographic display device to display the content and the additional content at specified times. In some embodiments, the queue comprises times of sporting events or movie screenings. The method may include causing a plurality of holographic display devices to display the content. The method may include causing a synchronized series of displays on a set of holographic devices that are installed throughout a public event facility, wherein the synchronized series lasts for a duration of a public event.

In some embodiments, causing the holographic display device to display the content comprises sending the content to holographic display device and disconnecting from the holographic display device prior to the display of the content by the holographic display device.

In some embodiments, causing the holographic display device to display the content comprises streaming the content directly from the server computer to a visual output mechanism on the holographic display device without storing the content in any persistent computer readable storage medium physically coupled to the holographic display device.

The method may include aggregating the received content with additional content from a separate source to produce an aggregate video comprising the received content and the additional content, and to cause the holographic display device to display the aggregate video in 3D. The method may include registering a user of the holographic display device, associating the user with a user account, and to causing the holographic display device to display the content based on a user profile attribute.

The method may include providing a mobile app for download. The method may include accepting instructions from an installed version of the mobile app and controlling the display of the content according to the instructions. The method may include receiving an input from a user's use of a mobile device and controlling the display of the holographic content according to the input. In some embodiments, the content comprises a game.

The method may include re-skinning the holographic display device by causing the display device to replace a first set of thematic elements visible in displays with a second set of thematic elements visible in the displays. In some embodiments, the first set and the second set of thematic elements comprise trademarks. The method may include re-skinning a mobile app on a mobile device simultaneously with re-skinning the holographic display device and while the mobile device is interacting with the holographic display device.

In certain aspects, the invention provides a holographic poster device that has a body supporting a display area and a computing device. The computing device includes a processor, a memory, and a display processing means (e.g., a video card connected via an expansion port on a motherboard or an integrated graphics chipset on a motherboard) and is operable to make a holographic image appear in the display area. The body may be in the form of a pedestal configured to sit on a floor with the display area at the top of the pedestal, preferably at least a few feet above the floor. The display area uses an electronic display source and a visible display area which can include, for example, a panel of at least partially reflective material disposed above the electronic display source at an angle with respect to the horizontal. In some embodiments, the material is a beam splitter at an angle between 35° and 65°. In certain embodiments, the display area uses an electronic panel disposed substantially horizontally when the pedestal is sitting on the floor, and a panel comprising an at least partially reflective material disposed at an angle above the electronic panel (e.g., between about 40° and about 50°).

The computing device operates to display images in the display area and may further include a network connection device such as a Wi-Fi card, Ethernet jack, or cellular modem. The device can use a wireless connection mechanism to exchange information with a handheld apparatus nearby such as the smartphone of a passerby.

In certain embodiments, the computing device is operable to stream images from a distal source while receiving a signal through the network connection device and display images from the memory while not receiving a signal through the network connection device.

A holographic poster may further include such features as stereo speakers, a touch-sensitive input device, a camera, others, or a combination thereof. The computer device can perform 3D processing such as z buffering on data captured by the camera. In some embodiments, the poster includes a graphics card comprising a RAM chip and a graphics processing unit.

In certain aspects, the invention provides a holographic display device that includes a memory coupled to a processor and operable to receive from a mobile device information identifying a user of the mobile device. The display device can register a user of the mobile device as a present user of the holographic device, receive an input from the registered user, and present a holographic display that includes content governed by the input. Preferably, the content comprises an interactive display. In some embodiments, the interactive display includes holographic images of characters and the display device can receive controlling input originating from the user's use of the mobile device and control the holographic images of the characters according to the controlling input.

The display device may include additional features such as a camera to perform, along with the processor, a facial recognition process to receive the information identifying the user. Thus the holographic display may include an image of a face and an animated interaction of the image of the face with the user. In certain embodiments, the display device is operable to determine the identity of the user and then to select a likely content preference of the user based on the facial recognition operation.

In certain aspects, the invention provides a holographic poster that includes a pedestal to sit on a floor, a beam splitter disposed at an angle to the horizontal at the top of the pedestal, and an image source configured to cast an image onto the beam splitter. A computer device coupled to the image source provides display content. The image source may be a flat-panel monitor or other image generation means. The image source may be concealed from the view of a person standing near the poster. In certain embodiments, the beam splitter is at least about four feet above the floor. In general, the computer device includes a processor coupled to a memory and may include a graphics card that itself has a graphics processor. The computer device may be operable to receive the display content from a server computer and store the display content in memory therein. In some embodiments, the computer device is operable to exchange information with a mobile device nearby and control the display content according to user input received via the mobile device.

The holographic poster may further include a sensor to detect motion within a few feet of the device. The computer device can cause the display content to form a holographic video mimicking the detected motion, thus providing an interactive or user-controlled display.

The invention provides devices and methods for displaying holographic content that is influenced by the motions of a user. A user may initiate, control, or interact with a holographic display and thus feel personally engaged and interested in the contents and progress of the display. Devices of the invention use sensor systems that can detect the approach of a user, detect a face, detect motions such as hand motions, or recognize facial expressions. The detected motions are used by a computer in rendering content for the display. For example, facial expressions can be mapped onto stored emotion categories to select content that suits a user, or hand motions can be analyzed and mimicked within the display to create an image of the user's hand manipulating a holographic depiction of an object. Devices of the invention may be employed to create multi-user experiences such as holographic games or multi-device displays such as a holographic video with content that follows a user as the user travels past a series of holographic displays. Since the user perceives that their motions are influencing and controlling the content of the display, the user is naturally engaged, and the content of the display is effectively communicated to the user.

In certain aspects, the invention provides a holographic display device that includes a sensor system configured to detect a motion and output data describing the motion, a computer device with a processor and coupled to the sensor system and operable to receive the data and render a hologram that is influence by the motion, and a holographic projection system coupled to the computer device and operable to display the hologram that is influenced by the motion. The sensor system may include any suitable sensors such as one or more of a motion sensor, a camera, a depth sensing camera, a microphone, a compass, a GPS device, a light sensor, or a combination thereof. In some embodiments, the computer device includes program instructions stored in a memory that describe an item, and is operable to render the hologram to show the item being moved in response to the motion. The holographic display device may be installed for use in a location for public entertainment such as a movie theater lobby or sports arena.

The holographic projection system may use a display source screen and optionally a display panel including a material with reflective properties. Such a material may be provided by a semi-reflective transparent plate and the display panel may be disposed at angle θ relative to the display source screen with 15°<θ<85° (e.g., 25°<θ<65°).

In some embodiments, the motion includes gestures performed by the hand of a user and the computer is operable to render the hologram to include a holographic hand performing the gestures. The motion may include an approach of a face, with the computer operable to render the hologram to include content acknowledging a presence of a person. Optionally, the motion includes an expression of a face, and the computer performs a facial recognition operation and selects a category representing an inference about a present disposition of a person. In certain embodiments, the computer is operable to use the selected category to select stored content and render the hologram to include the selected stored content. The computer may perform a mapping operation such as mapping the selected category to an emotion. The computer can be used to execute a brand choice operation to choose a brand to include in the hologram based on the emotion. Preferably, the facial recognition operation, the mapping operation, and the brand choice operation each involve a software module that can be updated independently of the others.

Any suitable holographic content can be displayed including, for example, video clips, games, rendered animation, text, brands (e.g., trademarks), or other content. The hologram could include one or more animated characters, for example, acting out a scene influenced by the motion of the user or interacting with the user. In certain embodiments, the sensor system is operable to detect motion from a plurality of users and the computer device is operable to render the hologram to include a depiction of interaction among the plurality of users. Additionally or alternatively, the holographic display device may use the computer to communicate with another, similar holographic display device to participate in a multi-device display. The multi-device display may be synchronized to an inferred speed at which a user will pass a plurality of locations.

In other aspects, the invention provides a holographic display method that includes detecting motion with a sensor system, outputting data describing the motion from the sensor system, receiving—using a computer device that includes a processor and coupled to the sensor system—the data and rendering a hologram that is influence by the motion, and displaying the hologram that is influenced by the motion using a holographic projection system coupled to the computer device. The method may include steps such as rendering the hologram to show an item being moved in response to the motion, rendering the hologram to include a holographic hand performing gestures performed by the hand of a user, rendering the hologram to include content acknowledging a presence of a person, others, or a combination thereof. In certain embodiments, the motion includes an expression of a face, and the method further includes performing a facial recognition operation and selecting a category representing an inference about a present disposition of a person. One may further include using the selected category to select stored content and rendering the hologram to include the selected stored content. The method may further include performing a mapping operation by mapping the selected category to an emotion. In some embodiments, methods include executing a brand choice operation to choose a brand to include in the hologram based on the emotion. Preferably, the facial recognition operation, the mapping operation, and the brand choice operation each involve a software module that can be updated independently of the others.

In some embodiments, displaying the hologram includes operating a display source screen. This may include casting light from the display source screen onto a display panel with a material having reflective properties. For example, the material may include a semi-reflective transparent plate. The display panel may be disposed at angle θ relative to the display source screen with 15°<θ<85°. In some embodiments, 25°<θ<65°.

Methods of the invention may include detecting motion from a plurality of users and rendering the hologram to include a depiction of interaction among the plurality of users.

In some embodiments, the computer is operable to communicate with another, similar holographic display method to participate in a multi-device display. The multi-device display may be synchronized to generate a cohesive narrative.

Aspects of the invention provide a holographic display delivery method that includes using a server computer comprising a tangible, non-transitory memory coupled to a processor for receiving content from at least one source, connecting to a remote holographic display device, transmitting the content to the holographic display device, and causing the holographic display device to display the content, preferably influenced by a detected motion or expression of a user. The method may include receiving additional content and using a queue to cause the holographic display device to display the content and the additional content at specified times. In some embodiments, the queue comprises times of sporting events or movie screenings. The method may include causing a plurality of holographic display devices to display the content. The method may include causing a synchronized series of displays on a set of holographic devices that are installed throughout a public event facility, wherein the synchronized series lasts for a duration of a public event.

In some embodiments, causing the holographic display device to display the content comprises sending the content to the holographic display device and disconnecting from the holographic display device prior to the display of the content by the holographic display device.

In some embodiments, causing the holographic display device to display the content comprises streaming the content directly from the server computer to a visual output mechanism on the holographic display device without storing the content in any persistent computer readable storage medium physically coupled to the holographic display device.

The method may include aggregating the received content with additional content from a separate source to produce an aggregate video comprising the received content and the additional content, and to cause the holographic display device to display the aggregate video in 3D. The method may include registering a user of the holographic display device, associating the user with a user account, and to causing the holographic display device to display the content based on a user profile attribute.

The method may include providing a mobile app for download. The method may include accepting instructions from an installed version of the mobile app and controlling the display of the content according to the instructions. The method may include receiving an input from a user's use of a mobile device and controlling the display of the holographic content according to the input. In some embodiments, the content comprises a game.

The method may include re-skinning the holographic display device by causing the display device to replace a first set of thematic elements visible in displays with a second set of thematic elements visible in the displays. In some embodiments, the first set and the second set of thematic elements comprise trademarks. The method may include re-skinning a mobile app on a mobile device simultaneously with re-skinning the holographic display device and while the mobile device is interacting with the holographic display device.

In certain aspects, the invention provides a holographic poster device that has a body supporting a display area and a computing device. The computing device includes a processor, a memory, and a display processing means (e.g., a video card connected via an expansion port on a motherboard or an integrated graphics chipset on a motherboard) and is operable to make a holographic image appear in the display area. The body may be in the form of a pedestal configured to sit on a floor with the display area at the top of the pedestal, preferably at least a few feet above the floor. The display area uses an electronic display source and a visible display area which can include, for example, a panel of at least partially reflective material disposed above the electronic display source at an angle with respect to the horizontal. In some embodiments, the material is a beam splitter at an angle between 35° and 65°. In certain embodiments, the display area uses an electronic panel disposed substantially horizontally when the pedestal is sitting on the floor, and a panel comprising an at least partially reflective material disposed at an angle above the electronic panel (e.g., between about 40° and about 50°).

The computing device operates to display images in the display area and may further include a network connection device such as a Wi-Fi card, Ethernet jack, or cellular modem. The device can use a wireless connection mechanism to exchange information with a handheld apparatus nearby such as the smartphone of a passerby.

In certain embodiments, the computing device is operable to stream images from a distal source while receiving a signal through the network connection device and display images from the memory while not receiving a signal through the network connection device.

A holographic poster may further include such features as stereo speakers, a touch-sensitive input device, a camera, others, or a combination thereof. The computer device can perform 3D processing such as z buffering on data captured by the camera. In some embodiments, the poster includes a graphics card comprising a RAM chip and a graphics processing unit.

In certain aspects, the invention provides a holographic display device that includes a memory coupled to a processor and operable to receive from a mobile device information identifying a user of the mobile device. The display device can register a user of the mobile device as a present user of the holographic device, receive an input from the registered user, and present a holographic display that includes content governed by the input. Preferably, the content comprises an interactive display. In some embodiments, the interactive display includes holographic images of characters and the display device can receive controlling input (e.g., originating from the user's use of the mobile device) and control the holographic images of the characters according to the controlling input.

The display device may include additional features such as a camera to perform, along with the processor, a facial recognition process to receive the information identifying the user. Thus the holographic display may include an image of a face and an animated interaction of the image of the face with the user. In certain embodiments, the display device is operable to determine the identity of the user and then to select a likely content preference of the user based on the facial recognition operation.

In certain aspects, the invention provides a holographic poster that includes a pedestal to sit on a floor, a beam splitter disposed at an angle to the horizontal at the top of the pedestal, and an image source configured to cast an image onto the beam splitter. A computer device coupled to the image source provides display content. The image source may be a flat-panel monitor or other image generation means. The image source may be concealed from the view of a person standing near the poster. In certain embodiments, the beam splitter is at least about four feet above the floor. In general, the computer device includes a processor coupled to a memory and may include a graphics card that itself has a graphics processor. The computer device may be operable to receive the display content from a server computer and store the display content in memory therein. In some embodiments, the computer device is operable to exchange information with a mobile device nearby and control the display content according to user input received via the mobile device.

The holographic poster may further include a sensor to detect motion within a few feet of the device. The computer device can cause the display content to form a holographic video mimicking the detected motion, thus providing an interactive or user-controlled display.

### BRIEF DESCRIPTION OF THE DRAWINGS

FIG. 1 shows a holographic poster according to certain embodiments.

FIG. 2 gives a hardware design for a holographic poster.

FIG. 3 diagrams software components of certain embodiments.

FIG. 4 depicts a system for connecting a holographic poster and providing content.

FIG. 5 illustrates methods of delivering content.

FIG. 6 illustrates connection to a mobile device via Bluetooth.

FIG. 7 illustrates connection between a mobile device and a holographic poster via NFC.

FIG. 8 depicts the operation of integrated motion sensors.

FIG. 9 shows use of a camera for capture of 3D data and user control of display.

FIG. 10 shows a touch screen on a holographic poster.

FIG. 11 gives a detailed view of the display area of a holographic poster.

FIG. 12. shows steps of configuring holographic devices.

FIG. 13 illustrates systems according to certain embodiments of the invention.

FIG. 14 diagrams one method for processing content.

FIG. 15 illustrates a system for content broadcasting and scheduling.

FIG. 16 shows real-time streaming according to systems and methods of the invention.

FIG. 17 shows remote programming of a cloud URL to playback.

FIG. 18 presents downloading of content from remote servers.

FIG. 19 illustrates a user approaching holographic device and being.

FIG. 20 diagrams a methods for registering a user.

FIG. 21 depicts a user interacting with the holographic device.

FIG. 22 illustrates a full server approach.

FIG. 23 illustrates a semi-server approach.

FIG. 24 depicts an architecture for content proxying.

FIG. 25 depicts a social a mechanism of implementing a social communication engine.

FIG. 26 illustrates use of a system for dynamic branding.

FIG. 27 illustrates a system employed for data management.

FIG. 28 describes data flow to a holographic device.

FIG. 29 illustrates how a user interacts with the sensor box and sees virtual.

FIG. 30 depicts hand configuration, orientation, and translation.

FIG. 31 illustrates a process flow for the mapping of user's hand to the virtual hand.

FIG. 32 illustrates a single sensor region with multiple participants.

FIG. 33 illustrates a sensor array with multiple separate sensors.

FIG. 34 outlines hand movement tracking and conversion into virtual hand movement.

FIG. 35 shows facial expression mapping to holographic animation.

FIG. 36 diagrams a method of using facial recognition and mapping to trigger branding.

FIG. 37 gives a process for linking user motions with holographic actions.

FIG. 38 illustrates a rendering system.

### DETAILED DESCRIPTION

The invention provides systems, devices, and methods for a fully interactive holographic poster device with online or offline functionality. The holographic poster described herein relates to the hardware design of a fully self-contained holographic poster that may rely on a server connection for the purpose of updating software or content to the device or for remote maintenance of the device and to send user data from the device to the server. However, the holographic poster 101 can function completely and effectively offline without any outside connection. This said, the holographic poster 101 is able to accept commands from an outside entity (client or server) so that it can be remotely programmed, configured, debugged, rebooted and scheduled.

FIG. 1 shows a holographic poster 101 according to certain embodiments. Holographic poster 101 generally includes display panel 105 extending above display source screen 109 and contains a computing system 121 therein. Holographic poster 101 101 may also include NFC device 125, speakers 129, support stand 133, hardware connections 137, stabilizing base 141, Wi-Fi device 145, sensor 149 (e.g., a motion sensor), Bluetooth device 153, camera 157 (e.g., a z-buffer camera), and one or any number of speakers 161.

In some embodiments, camera 157 is a stereo camera system. A stereo camera can detect and capture user gesture as a user interface in both 2d and 3d field. The purpose is to create an interactive user interface, thus making it more interesting to the viewer. Applications include providing information, games, point-of-purchase/point-of-sale functions, or a combination thereof.

In some embodiments, device 101 includes a gesture detection technology such as that described in U.S. Pat. No. 8,269,175 to Alameh; U.S. Pub. 1213/0009896 to Zaliva; or U.S. Pub. 1212/0313882 to Aubauer, the contents of each of which are incorporated by reference. Gesture detection can be provided by hardware and a software application.

In some embodiments, speakers 161 may include a 3D speaker system to create surround audio to create the illusion of depth and movement in order to enhance the illusion of depth and presence. The purpose could be to assist the user in orientation when being directed in a certain way, audio can follow.

In some embodiments, speakers 161 may include a directional speaker system. Directional audio has the ability to direct messages to a very specifically located audience, down to one person only. This means that messages can be tailored very narrowly to target a higher value audience. Applications could be gaming, retail, banking, POS, POP. In some embodiments, device 101 includes a microphone. A microphone can allow for voice a voice-command controlled user interface. Holographic poster 101 may additionally include, for hardware connections 137, a CATS network connection device. This device could control network based devices as well as handling remote devices, servers and folders. In general, a holographic poster 101 according to the invention will include a computer system 121 to provide functionality.

FIG. 2 shows design of hardware components of a computer system 121 provided with holographic poster 101. A computer system 121 will generally include a processor 205 coupled to a memory 209 via a bus. FIG. 2 depicts a number of optional components as well. The hardware architecture for holographic poster 101 preferably includes a motherboard configuration that can include the following: a processor 205, a memory 209, a bus, a graphic card 213, a sound card, an Ethernet card or connection, i/o interfaces and tangible, non-transitory storage medium memory 219. Graphics card 213, called a video card or graphics adaptor in embodiments, is a structure that can provide display processing means.

Storage 219 could include a solid-state drive (SSD), hard disk drive (HHD), optical drive, flash memory, or a combination thereof. In a preferred embodiment, storage 219 includes an SSD, which is more resistant to physical shocks that might occur to the device. Storage 219 may store the instructions and code for the operating system (OS) and it may store any software that would run on the OS. The OS could be Linux, Windows, Mac OS, or some other embedded operating system. A preferred embodiment includes a custom version of Linux (using the latest build of Ubuntu) optionally stripped of all windowing systems and accepting remote secure shell (ssh) login and input.

The video card, or graphics card 213, renders holographic display information and relays the information to a display area capable of displaying a hologram (see, e.g., FIG. 11). Graphics card 213 can be a dedicated video card connected via an expansion port on the motherboard; an integrated graphics chipset on a motherboard; can be embodied within CPU 205; can be provided by one or more GPU located in poster 101 or in a remote computer such as a server; can have other structures and forms known in the art; or a combination thereof. In some embodiments, the poster includes a graphics card comprising a RAM chip and a graphics processing unit.

Graphics card 213, also occasionally called visual processing unit (VPU) or graphics processing unit (GPU), can provide a specialized electronic circuit to manipulate and alter memory to accelerate the building of images (e.g., within a frame buffer). Graphics card 213 is efficient at manipulating image data, and can include resources for 2D acceleration, 3D functionality, graphics-related application programming interfaces (APIs) such as OpenGL or DirectX, or general purpose GPU (GPGPU) development environments such as OpenCL or CUDA by NVIDIA. Graphics card 213 can include programmable shading (e.g., each pixel can be processed by a short program that can include additional image textures as inputs; each geometric vertex can be processed by a short program; etc.). Such functionality can be offered by OpenGL API, DirectX, and the GeForce chips by NVIDIA. Graphics card 213 may further include support for generic stream processing.

Computer system 121 may include one or more of graphics card 213. Any suitable GPU can be used, including, for example, those made by Intel, NVIDIA, AMD/ATI, S3 Graphics (owned by VIA Technologies), and Matrox. Card 213 can include a programmable shader or other resources to manipulate vertices and textures, perform oversampling and interpolation techniques to reduce aliasing, and very high-precision color spaces. In certain embodiments, graphics card 213 is a GTX680 (GK104 core), GT640M (GK107 core), GTX 660 Ti (GK104 core), GTX 660 (GK106 core), GTX 650 (GK107 core), or GTX690 by NVIDIA or a Radeon by AMD. In some embodiments, graphics card 213 includes an integrated ARM CPU of its own. Graphics card 213 may operate via OpeNVIDIA, OpenCL, or CUDA, an SDK and API that allows using the C programming language to code algorithms. graphics card 213 can process many independent vertices and fragments in parallel. In this sense, graphics card 213 is a stream processor and can operate in parallel by running one kernel on many records in a stream at once. In certain embodiments, system 121 a plurality of parallelized cards 213 (e.g., each itself configured to perform parallel operations). Parallelized GPU computing can be implemented using any suitable platform such as, for example, products from NVIDIA, or OpenCL. OpenCL is an open standard defined by the Khronos Group. OpenCL solutions are supported by Intel, AMD, NVIDIA, and ARM.

A stream includes a set of records that require similar computation. Streams provide data parallelism. Kernels are the functions that are applied to each element in the stream. In the GPUs, vertices and fragments are the elements in streams and vertex and fragment shaders are the kernels to be run on them.

As shown in FIG. 2, computer system 121 preferably includes an audio card. An audio card manages input sounds from the microphone and output sounds to the speakers. In a preferred embodiment the speakers would be a set of directional 3D speakers. An input/output or i/o controller would be used to communicate with and control a sensor device and a touch screen device for receiving user input. The bus on the mother board would also have a connection to a special Z-buffer camera (capable of 3D recording) to receive image data from the camera and transmit data to it. The bus is also connected to a Bluetooth device that transmits and receives a Bluetooth signal that can be used to communicate with a mobile device held by a user interacting with the holographic poster 101. The bus is also connected to an integrated Wi-Fi router broadcasting the SSID of the holographic poster 101 and creating another wireless communication channel with users. In some embodiments, the motherboard bus is also connected to near field communication (NFC) device. The NFC device also used for identification and registration of an approaching user. NFC standards cover communications protocols and data exchange formats, and are based on existing radio-frequency identification (RFID) standards including ISO/IEC 14443. In some embodiments, poster 101 includes components of the contactless system sold under the trademark FELICA by Sony Corporation (Tokyo, Japan). The standards include ISO/IEC 18092 and those defined by the NFC Forum.

In addition to storage device 219 storing an operating system, device 219 may also store custom software. The custom software, when executed, can perform one or more of the following: fetching playlists, content and branding information from a server and initiating, preparing or otherwise setting up the hardware to playback the downloaded content; offering interaction choices and selections to a user interacting with holographic poster 101; managing user queues for the holographic poster 101; controlling the i/o interfaces and managing the data going between the mother board and the i/o devices; performing and managing data capture; managing (via the video card) the 3D rendering for the hologram and controlling the hologram display; managing server updates; monitoring the health and repair of the holographic poster 101 software and hardware; remote login support; others; or a combination thereof. In a preferred embodiment the OS is stripped of all modules or elements except for those required for the said software. The said required modules that remain in the OS are part of the support libraries (for example, Unity3D engine) and basic monitoring and hardware health assessment procedures.

In some embodiments, device 101 includes a computer for handling content scheduling. This computer would handle precise play out of appropriate content at a pre-determined time and date set by an admin (e.g., personnel or remote computer operating poster 101). Appropriate content scheduling may be important to certain implementations and embodiments as advertising revenue can be maximized by not displaying advertising during times when a target audience is not likely to be viewing. For example, a sports arena could select certain ads to display depending on which team won a game just as that team won that game so that enthused fans would see the ad moments after the win as those fans filed from the arena.

In some embodiments, device 101 includes a computer system 121 with components for handling automatic remote download. Computer system 121 handles the download of off-site content at a pre-determined time, for instance at midnight every day. The system allows the admin to set a specific folder in a specific server and the system will automatically “look” for new files in the folder. If files are present, it will start download and play out as scheduling determines.

Holographic poster 101 may include digital multiplex (DMX) software per the standard for digital communication networks. The computer system 121 would handle the DMX timeline controlling lighting and other DMX controlled machines.

The computer system 121 can be included to handle touch interface software. The computer would handle input from a simple touch screen and translating input to play out of appropriate content.

The computer system 121 can handle synched multiple stream content, i.e., handle software with timeline to play out separate streams of content in synch. This would be used in systems with more than one LCD screen. For instance systems with one horizontally positioned LCD for refracted effects and one LCD screen for back drop images assembled in one array.

Holographic poster 101 may include facial recognition software. The computer would handle user-based input like facial expressions. For instance, if the system recognizes a smile, the system while activate an appropriate response or play out appropriate content.

Holographic poster 101 may include software that allows a device (smartphone, tablet etc.) to operate as a remote control. The computer would handle use input from outboard devices like smartphones and tablets. These would have a simple user interface like simple buttons that would control play out of appropriate content. In certain embodiments, the invention provides a user mobile app 427 that can be installed on the outboard device to provide a custom interface for controlling holographic poster 101.

Computer system 121 provides for control, scheduling, and storage of content and can also control audio, gesture processing, camera information, i/o devices. For example, computer system 121 can: provide control of audio like automatic level control in relation to ambient noise or stereo positioning relation to both content and user; handle simple gesture use input and control or play out appropriate content; handle user generated 3d and 2d gesture input and translate to appropriate response or play out of content; handle all input or output devices controlled by RS232 protocol; or a combination thereof. Computer system 121 can be provided as a single unit (e.g., as an off-the-shelf PC such as a desktop or laptop by Dell (Round Rock, Tex.)) or as a system of computer components and devices. Computer system 121 will generally operate by executing instructions provided by software.

FIG. 3 diagrams software components of certain embodiments. While a holographic poster 101 can interact with a user independently from a server, the software of holographic poster 101 may continually listen for commands from a remote server if an internet connection is available. These said commands can cause software to update, reconfigure, re-schedule or execute any other command sent from the server where client accounts are managed.

FIG. 4 depicts a system 401 with poster 101 connected to server 409 via network 421. An admin personnel can control poster 101 directly or via server 409 through the use of admin terminal 415. Poster 101 can be connected to a mobile device 425 that includes a user mobile app 427 and input/output mechanisms 437.

The hardware based implementation described herein is different from a server-based implementation because a hardware based implementation does not depend in real time on a server sending information for rendering the display. Rather, the hardware based implementation downloads all the information that it requires in advance and can then operate independently of the server (except for updates and maintenance). This said downloaded information includes content in the form of scripting modules, geometry, textures, animations, audio, video, images and everything else necessary to render the proposed branded experience including instructions on how to interact with the user. A primary script module would be responsible for initializing the holographic poster 101 and using the said downloaded content to display the initial hologram or series of holograms. The same script module, or a different one, would use a secondary touch screen for displaying menu options and receiving and processing text entry from the touch screen as well as receiving and processing touch gesture interactions. Once the initial holograms are displayed, the holographic poster 101 would accept input from a user via the sensors, touch screen or wireless communication (Wi-Fi, Bluetooth or NFC).

FIG. 5 illustrates methods of delivering content to a user. If a user has no mobile device 425, then a user can interact with a holographic poster 101 device if they find it and walk up to it. Without a mobile device 425, the user controls the holographic poster 101 using a touch screen or sensors on holographic poster 101. These controls allow the user to make selections or otherwise interact with the holographic poster 101. When the user wishes to end the session they can choose to exit through a menu option or they can simply walk away from the device which automatically terminates the session and allows another user to take control. If a user does have a mobile device 425 such as a mobile phone or tablet, and if they have user mobile app 427 installed then they can use the app on their mobile device to find the nearest holographic poster 101. This can be done using a pre-defined downloaded map of permanent holographic poster 101s combined with the mobile device's GPS navigation system, or user mobile app 427 can perform a search for a wireless signal (via Wi-Fi, Bluetooth or NFC) from a holographic poster 101. The mobile app can then determine the route to the holographic poster 101 using information from the wireless signal in combination with the mobile's GPS determined location.

In some embodiments, user mobile app 427 searches a plurality of wireless communications (Bluetooth, Wi-Fi and NFC) for the signal of a holographic poster 101. Device 525 may preferably utilize Wi-Fi given that it has superior signal range and can easily be setup as a local wireless network if there are more than one holographic poster 101 or if additional routers are used. If the user has a mobile device yet does not have the user mobile app 427 installed, then the user would have to find the holographic poster 101 using other methods such as through word of mouth or by sight.

Once a user finds holographic poster 101, the user decides whether to control the holographic poster 101 either with their mobile device 425 or with the holographic poster 101's input/output mechanisms 437 (e.g., touch screen, button(s), sensors, microphone, camera, others, or a combination thereof). If the user has a mobile device 425 and wishes to use it to control the holographic poster 101, mobile app 427 can be installed since the user mobile app 427 will manage the communication with the holographic poster 101 and convert the input on the device 425 to an input that can be used by the holographic poster 101. The user mobile app 427 will manage the communication with the holographic poster 101 and also take care of queuing if there are multiple users present at the same holographic poster 101. Once a user has been queued and then enters a session with a holographic poster 101 they can use their mobile device to control the holographic poster 101 using instructions that can appear on the holographic poster 101 and that may also appear on the user's mobile device 425. To end a session the user can choose to quit via the user mobile app 427 or simply by walking away from the holographic poster 101 thus freeing the holographic poster 101 for another user.

A user with a mobile device is not required to use the said mobile device to control the holographic poster 101. The user always has the choice of controlling the holographic poster 101 directly with the sensors or with the touch screen. The user can choose to find the nearest holographic poster 101 with their user mobile app 427 and then once arrived at the holographic poster 101 they can use the direct controls on the holographic poster 101 device instead of their mobile device. This might be the case if the batteries are low in the user's mobile device or if they simply prefer using the direct controls.

In some embodiments, device 101 includes one or more devices for wireless connection.

A WIFI network device can control a wireless connection for remote control, content download, scheduling and remote diagnostics. Wi-Fi network device could be provided as part of computer system 121. Holographic poster 101 could include Near Field Connectivity (NFC) devices like NFC enabled devices like smartphones or tablets. This would be appropriate for systems in close proximity with the unit. Holographic poster 101 could include one or more device to handle Bluetooth input and output.

FIG. 6 illustrates connection between user device 425 and poster 101 via Bluetooth. Bluetooth has wider bandwidth than ordinary Wi-Fi and may provide a faster response to user input. Poster 101 may include one or more Bluetooth sensor for identification and control. Bluetooth sensors mounted in the holographic poster 101 frame are used to interact with the mobile devices of users. A user could connect to a holographic poster 101 via Bluetooth on their mobile device 425. This connection would be used for the purposes of identifying the two devices and used as a channel through which the mobile device would control the holographic poster 101. As illustrated in FIG. 6, a user would have to come close enough to the holographic poster 101 so that their mobile device is within the range of the Bluetooth device. The mobile device would then receive instructions allowing the mobile device to control the holographic poster 101 through user mobile app 427.

FIG. 7 illustrates connection between user device 425 and poster 101 via NFC. The NFC device would be connected to the motherboard. An NFC communication channel is used in the same way as Bluetooth and provides a secondary channel to interact with the holographic poster 101. The range of NFC is significantly shorter than the range for Bluetooth and therefore this would be used primarily for identification.

A Wi-Fi router can be built into a holographic poster 101. This resident Wi-Fi router would emit a custom SSID label name so that user mobile app 427 users could find it. While the Wi-Fi router is connected to the motherboard it is not necessarily integrated into the motherboard. If a plurality of holographic poster 101 devices are present in the same area (such as in an stadium), then the Wi-Fi routers in the different devices can form a wireless network and share information between devices and users.

Holographic poster 101 could include motion sensors (e.g., Leap Motion or Kinect type devices).

FIG. 8 depicts the operation of integrated motion sensors. Provided that a user is standing in front of the holographic poster 101, the motion and gesture sensors may capture user motion in 3D space as well as gestures (these could also capture facial expressions). This motion and gesture data is relayed to the scripting modules running on the central processor so that they can modify the currently rendering holograms accordingly. In the illustration in FIG. 8 the motion of the user (in this instance the motion of the user's hand) is used to control the selection of items on the screen.

Holographic poster 101 could include Z-buffer camera supporting both 2D video capture, 3D video capture, or both.

FIG. 9 shows use of a camera such as an integrated depth sensing camera for additional user input and control. In a preferred embodiment a special z-buffer camera would be used as a depth-sensing camera to gather additional information that can be used by the holographic poster 101. (A z-buffer camera is capable of capturing 3d information.) The additional input from this camera could be used in conjunction with the motion sensor data to more accurately track a user's movements. It can also be used for standard 2D photo and video capture for live integration with currently playing holograms. Data captured with this special camera is sent to the modules running on the processor which also manages the incoming data from the sensors.

One exemplary depth sensing camera system for use with poster 101 is the real-time depth sensing camera system sold under the trademark ZCAM by JVC (Wayne, N.J.). A depth sensing camera system can operate by time-of-flight principles and include a near-infrared (NIR) pulse illumination component, an image sensor with a fast gating mechanism, and a software component. Based on the known speed of light, a depth sensing camera system coordinates the timing of NIR pulse wave emissions from the illuminator with the gating of the image sensor, so that the signal reflected from within a desired depth range is captured exclusively. The amount of pulse signal collected for each pixel corresponds to where within the depth range the pulse was reflected from, and can thus be used to calculate the distance to a corresponding point on the captured subject. Three dimensional imaging is discussed in U.S. Pub. 2012/0317511 to Bell; U.S. Pub. 2012/0268572 to Cheng; U.S. Pub. 2012/0287247 to Stenger; U.S. Pub. 2012/0249740 to Lee; and U.S. Pub. 2012/0242795 to Kane, the contents of each of which are incorporated by reference.

Holographic poster 101 could include one or more touch screen surface for interfacing and control.

FIG. 10 shows a touch screen 1001 on poster 101. Secondary embedded touch devices such as a touch screen 1001 can also be include on the holographic poster 101 device. These touch devices would be used for additional user interactions and controls as well as possible registration and menu support. For example a user might be required to input their name (or a code) on the touch screen and then back up and use the motion sensors to control the holographic poster 101 device.

The inclusion of a holographic display area in holographic poster 101 provides attractive communication and visual benefits.

The display for the holographic poster 101 uses a visual effect that mimics holography and creates the illusion of a 3D image. The display area is one sided and open which allows for the image to be set free floating in front of the display components. This design allows for the unit to be used for commercial purposes in public places; such as for example in a cinema lobby. The display area is illustrated in FIG. 11.

FIG. 11 gives a detailed view of the display area of poster 101 showing display panel 105 extending from attachment joint 1109. Connector 1119 can connect (e.g., via HDMI) to a source such as a graphics card or a player. Display source screen 109 is disposed under panel 105.

The glass attachment element 1109 holds the face of the glass at a 45 degree angle from the horizontal with the lowest point of the glass held between 2 and 4 inches above the display screen. In some embodiments, panel 105 includes a standard 40/60 Beam splitter glass with 40% reflective properties on the front and 0.05% reflection on the back side of the glass. The 2 to 4 inch separation from the bottom of panel 105 to the face of display source screen 109 creates the illusion of distance between the glass and the image content. Materials for use in panel 105 including beam splitter screens are discussed in U.S. Pat. No. 5,771,124; U.S. Pat. No. 5,572,229; U.S. Pub. 1212/0300275; U.S. Pub. 2009/0256970; and U.S. Pub. 2002/0075461, the contents of each of which are hereby incorporated by reference in their entirety for all purposes.

Display source screen 109 is preferably positioned below and pointing upwards towards panel 105. In a preferred embodiment display source screen 109 is a high definition display and with a bright output and high contrast. For example, a good display source screen 109 would be a flat LCD with a 16:9 aspect ratio, high resolution (1080 horizontal pixels), high brightness (1500 nits) and high contrast ratio (3000:1). The dimensions of the display area will depend on the dimensions of the display source screen 109. In a preferred embodiment the display source screen 109 would be a 47 inch LCD display and the dimensions of the display area above the display screen would be approximately 24″×42″×26″.

One exemplary screen placed horizontally to create refracted image on the panel 105 is a 46″ 3000 nit fanless high brightness LCD with narrow bezel sold under the model name ds46104 by DynaScan Technology, Inc. (Irvine, Calif.). In some embodiments, device 101 includes a stereoscopic LCD screen as display source screen 109 to perform the same purpose as LCD screen but stereoscopic. Would create actual stereoscopic image on MBG.

Device 101 could optionally include a privacy filter. A privacy filter would reduce the viewing angle to the LCD screen thus enabling the current screen height (5′8″) could be lowered without revealing the LCD screen image to the viewer.

Panel 105 may include a beam splitter such as a beam splitter glass sold under the trademark MIRONA by Schott North America, Inc. (Elmsford, N.Y.). Panel 105 is the termination point of the image emanating from the LCD screen. The beam splitter glass is coated on the front with a high reflective surface and a none reflective surface on the back. The purpose of the front coating is to increase refraction and the purpose of the rear coating is to reduce refraction in an effort to avoid “ghosting”. An effect that comes from seeing a reflection of the LCD image on both sides of the glass. Since the glass is at an angle of 45 degrees, the ghosting would not be aligned and less bright, it would create the unfortunate sense of defocus.

In some embodiments, holographic poster 101 makes use of LED-imbedded beam splitter glass. It is now possible to seamlessly imbed LED lights in low iron glass before the coating process. This would produce LED light, seemingly free floating on the glass itself. The refraction of the LCD screen would appear behind the beam splitter because the distance to the LCD image will repeat itself in the reflection. This means that the LCD's imbedded in the beam splitter would appear in front of the reflected image. Obviously the imbedded LCD's would be very simple and create a sense of depth.

In some embodiments, holographic poster 101 uses a translucent LCD panel 105 with optically bonded beam splitter glass. Beam splitter glass can be bonded to a translucent LCD. This allows an actual image to be created directly on the beam splitter that would run with the refraction from the LCD or stereoscopic LCD. In some embodiments, a translucent LCD panel is layered on top of regular or stereoscopic LCD screen. A different approached that places the translucent LCD on top of the horizontally positioned LCD screen at a certain distance. This creates further physical depth in the refraction on panel 105.

In some embodiments, holographic poster 101 includes one or more additional backdrop LCD panel. To create a backdrop to the refracted effect, an LCD is placed at a certain distance behind the viewing direction of the beam splitter. Content would be either be streamed in synch with the refracted image or “freewheel” none intrusive background content to create visible depth. This would be the same size LCD panel as the Dynascan 46″ unit but may be less bright.

In some embodiments, holographic poster 101 include one or more additional stereoscopic backdrop LCD panel, similar to above, but using a stereoscopic LCD screen. This was tested this using a low res stereoscopic screen and it adds significant depth to the effect in the beam splitter.

In some embodiments, holographic poster 101 includes one or more of a backdrop lighting bar (DMX controllable). Such a simple color lighting bar enhances depth of field behind the effect. For instance a dark wall would decrease the depth effect, but if lit, the depth effect can be enhanced.

The holographic poster 101 display screen is connected to and receives the display information from a graphic card or graphic device. In a preferred embodiment the connection is made with a high definition video cable such as an HDMI cable. The connection between the display screen and the graphic card 213 can be a network connection (TCP/IP accessible via remote ssh or protocol). The graphic card renders the hologram display information according to the commands sent by the rendering engine which itself receives commands from the hologram scripting modules.

In some embodiments, holographic poster 101 includes directional speakers and a 3D audio system. The holographic poster 101 includes a speaker system that is connected to the rendering engine driven by the core software modules. The speaker system can use conventional speakers or it can incorporate more elaborate directional speakers or 3D audio system to provide surround sound for the user.

Microphone and sound capture systems can be included. In some embodiments, the holographic poster 101 includes an audio/sound capture device connected to the main motherboard and driven by the software modules.

In some embodiments, device 101 includes a network and scheduling enabled flash card or video player. An HD video player such as the media player unit sold under the name HD220 by BrightSign, LLC (Los Gatos, Calif.) or the video media player sold under the trademark EYEZUP by Grandtec USA (Dallas, Tex.) can be included. A video player and software components can allow user-based interface with content. In some embodiments, holographic poster 101 includes a device such as an RS232 controllable player. A video player can include a RS232 machine control protocol to allow machine control of the unit from outboard RS232 input like simple buttons, step activated mats and simple beam breakers.

Content generation can include methods described in U.S. Pub. 2012/0263433 to Mei; and U.S. Pub. 2003/0105670 to Karakawa. Other technologies adaptable for use with the invention are discussed in U.S. Pat. No. 6,512,607 to Windsor; U.S. Pub. 2011/0216160 to Martin; and U.S. Pub. 2009/0021813 to Moore.

In certain embodiments and aspects, the invention provides systems and methods for controlling and delivering content to holographic display devices. In certain embodiments, a holographic display device includes a kiosk that presents a 3D display including an image, video, or game. One or a plurality of these devices may be installed in public locations such as in movie theaters or sports arenas. The invention includes the insight that obtaining an optimum benefit from such devices can be had by employing a server system for controlling content and implementing the server system for adaptable content delivery, as described herein.

Systems of the invention include functionality for several related purposes such as customer registration, identification of holographic devices 101, and configuration of content for branding and brand delivery. One basic mechanism for registration, identification and configuration is shown in FIG. 12.

FIG. 12 shows steps of configuring holographic devices 101 and content to serve a customer (e.g., an entity that wants to communicate with a user through one or more device 101). In step 661 the system provides a customer with a registration code so that this customer can register on a specific website and create a customer account. The website is managed by the system and connects with the servers 409 on the backend. Access to the site, and therefore to the servers, is controlled by the system via their management of the website and the registration codes. Step 665 allows the customer to register on the secure website, create an account and create a profile. Once this account is created, the system can associate one or more holographic devices 101 with this account. The customer must first decide how many devices they need and whether they will be renting or buying the devices. With respect to branding, the customer has the choice of using single devices or creating groups of holographic devices 101. A group of holographic devices 101 would share the same branding information and presentation schedule. Once the number of devices and the grouping of said devices is known, then the system can associate specific holographic device 101 machines to cover the customer's request.

Step 689 (illustrated in FIG. 12) involves configuration of the holographic device(s) 101 on behalf of a customer. This configuration process includes the customer uploading branding information so that the system servers 409 may re-skin any user facing interfaces with the said branding information. This may include re-skinning of the holographic device 101 user interface and any visuals therein and it can also include the re-skinning of an interface of an associated mobile device 425.

The uploading of branding information includes the customer uploading specific content items with specific resolutions in order to satisfy the requirements of the resident user interface(s). Customers can represent different companies and brands so it is possible to configure different branding graphical elements with different holographic devices 101 or groups of holographic devices 101 that are associated with the same customer. A group of holographic devices 101 would share the branding information and thus the information would only need to be uploaded once.

FIG. 13 illustrates systems according to certain embodiments of the invention. As shown in FIG. 13, the holographic devices 101 are remotely located and IP accessible (across firewalls and routers either using open ports or some form of NAT traversal using Google Jingle or a similar mechanism). Holographic devices 101 may be named and grouped together with branding information. In the example illustrated in FIG. 13, the same customer may have groups for both a soft drink and an auto maker. The group name can be used as a reference when a customer decides to broadcast content to those devices via the secure website.

As shown in FIG. 13, holographic devices 101 may be provided as solo devices, one or more groups, or a combination thereof. Groups may be employed to deliver consistent brand information, where content is sourced from servers 409 and may be controlled by a customer portal 415, all accomplished through the use of a communication network 421. Using such systems, the invention provides methods for content upload and processing.

FIG. 14 diagrams one method for processing content to be displayed by a holographic poster 101.

With one or more holographic devices 101 associated with a customer account, a customer may upload content to be broadcasted to the holographic device(s) 101 or group of holographic devices 101. The uploaded content is preferably sent to the servers 409 via the secure website. The customer uploads content in any video format known to those in the art; including h.264, mpeg2, and avi. There is no requirement that the content be in any specific holographic format, rather the content can be in any standard video format. In a preferred embodiment the video would be in a high resolution format since better quality holographic images are generated with high resolution video. A process or module on the servers transcodes the uploaded content to an optimized adaptive streaming ready format and store it on a content delivery network (CDN) bucket. Current commercial CDNs include Amazon CloudFront, Akamai, and Bitgravity; however any appropriate CDN could be used. Uploaded content is not necessarily immediately displayed on the remote holographic device 101 but rather it indicates that this content is ready to be either broadcasted or downloaded to a holographic device 101 or group of holographic devices 101.

The broadcasting (or downloading) of the content from the CDN to any specific holographic device 101 occurs according to a schedule determined by the customer and approved by the system. The approval of the schedule by the system need not require an active review, but rather it can be automatically approved if the schedule complies with previously determined scheduling criteria. The scheduling information includes the time schedule for the display of content and the specific holographic devices 101 or groups of holographic devices 101 where the said content is to be displayed.

FIG. 15 illustrates a system for content broadcasting and scheduling. Any suitable broadcast scenario may be performed by systems of the invention, allowing for flexibility of configuration of holographic devices 101. For example, broadcasting may include real-time, adaptive streaming; remote programming of a cloud URL; downloading of content from a remote device; other methods; or a combination thereof.

FIG. 16 shows real-time streaming according to systems and methods of the invention. In broadcasting of content in real-time (adaptive streaming), a remote holographic device 101 that receives the content does not need to have local memory to store the content. The content must be streamed to this device and displayed as it streams in.

The remote holographic device 101 can access a content schedule list from a the system server and select specifically configured content from this list to stream back to the device at specific points in time. This configuration can incorporate the adaptive streaming model (for example mpeg-dash or HLS) which allows for the streaming content to be streamed at different rates depending on the specific bandwidth conditions for a given holographic device 101.

FIG. 17 shows remote programming of a cloud URL to playback. In this scenario the remote holographic device 101 has local memory and is behind a non-configurable firewall/router and may not be remotely addressed from a server. Because the holographic device 101 cannot be directly addressed from the server it must receive content indirectly via a web address (URL). To accomplish this the holographic device 101 must poll for content downloads from a specific URL, and once downloaded this content can be played back on the local device.

FIG. 18 presents downloading of content from remote servers 409. In this scenario the remote holographic device 101 has local storage and may be remotely addressed from servers 409 which can push content to this device. This type of holographic device 101 has full remote access using protocols including ftp, ssh, and web-day. In a preferred embodiment, device 101 will contain a web server accepting remote commands and uploads. This type of holographic device 101 may be entirely controlled from the server.

In whatever broadcasting methodology or combination of methodologies is employed, systems and methods of the invention can be used for user identification, registration, and queuing. In some embodiments, servers 409 include components to manage user identification, registration, and queuing.

Identification and registration preferably occur when a user has downloaded the mobile app 427. Identification may first begin when a user with a mobile app approaches a holographic device 101. In some embodiments, a user finds or registers with holographic device 101.

Upon approach, the mobile app will execute code that will perform an API call to the servers 409 to identify the user and determine if said user is already registered with the system and if this user has already interacted with this particular holographic device 101.

FIG. 19 illustrates a user approaching holographic device 101 and being identified and registered. In some embodiments, servers 409 contain a database (that may comprise master and slaves and replicated instances) that holds information describing all the types of users. There may be several types of users. A partial user is one that is identified but not registered. A registered user is one that is identified but only partially registered without a profile An interacting user is one that is identified, registered, and interacting holographic device 101. A fully acknowledged user is a user that has been identified, registered, has interacted and has also completed their profile data and permissions (permissions being the ability for servers 409 to capture more data from this user: for example, the permission to capture a user photo or to present some specific branded content to this user the next time they approach a particular holographic device 101).

FIG. 20 diagrams a methods for registering a user. As diagrammed, a user approaches a holographic device 101 and is identified via their mobile app 427. The user registers on the servers 409. User is queued for the given holographic device 101. The user may interact with the holographic device 101. In some embodiments, once a user is identified and registered, the system queue allows for the management of waiting lines for specific holographic devices 101. The system queue will be filled with users that have been identified and registered and are waiting to interact with the holographic device 101. A transparent layer maybe be added to the broadcasted content so as to inform local users when their turn will come to interact with the holographic device 101. Once a user has been called to interact with the holographic device 101, the system will switch control from the previous mobile device to the current user's device in order to receive commands to interact with the holographic device 101 content. In one embodiment the device content is reset after a change of user so as to give each new user a chance to start from scratch with clean menu selections.

In some embodiments, systems and methods of the invention employ a mobile interaction gateway. For example, taken together, components of servers 409 may comprise a mobile interaction gateway, which allows users to interact with the holographic device 101 content in real-time.

FIG. 21 depicts a user interacting with the holographic device 101 via a mobile interaction gateway and content engine. The mobile interaction gateway captures commands from the mobile device 425 and after filtering and processing passes them to the content engine to specifically modify the content based on those commands. In an exemplary embodiment, a user is in front of a holographic device 101 and is presented with a choice of two types of content. The user's mobile device 425 will allow them to choose between the two types of content and the mobile device 425 will send the command with this choice to the servers 409. The mobile interaction gateway receives the command and processes it.

The processing determines the link between the command and the content which the user has chosen. The chosen content is fetched from the content server of servers 409 and brought to the content engine, where it is processed for delivery to the holographic device 101, as illustrated in FIG. 21.

In certain embodiments, the invention provides systems and methods for content real-time rendering. The real-time content rendering engine provides dynamic and live services to render 3D animated content and broadcast it to the holographic device 101 for viewing. The real-time content engine takes input from the mobile interaction gateway under the form of processed and filtered user commands as well as from dynamic outside data channels (including RSS feeds, live sports scores/data, and weather data) in order to render from 5 to 30 frames per second of video to be streamed back to the holographic device 101. The processed and filtered user commands include relative movement such as the up, down, left and right arrows, or it can include specific keys, or information from motion sensors such as gestures, and more. The real-time content rendering engine is connected to a live streaming server that will further encode in real-time the incoming frames so as to stream them to the holographic device 101. This model removes the need for computing machinery at the holographic device 101 itself; however this model is compatible with having computing machinery at the holographic device 101 such as using computing and real-time rendering engines (Unity 3D for example). As such this model defines two different methods of distributing the functionalities between server and client device allowing for a full server or semi server based approach with the holographic device 101.

FIG. 22 illustrates the full server approach. In the full server approach, the incoming mobile commands are all processed at the server level. Using those processed commands the content is modified and rendered and encoded and ready for streaming. Only fully rendered video content is streamed to the holographic device 101 such that the holographic device 101 is only responsible for the displaying of the rendered content.

FIG. 23 illustrates the semi-server approach. In the semi-server approach, the mobile commands from the user are processed at the server level along with incoming data sources and then multiplexed and streamed to the holographic device 101. In this case the data streamed to the holographic device 101 is not completely rendered so the holographic device 101 would then be responsible for both the final rendering and display. In some embodiments, in the semi-server approach, some core content elements are downloaded to the holographic device 101 beforehand and the data is made available for local real-time rendering. Also, the holographic device 101 may include storage capacity to hold the content and uses a content engine capable of real-time rendering.

Additionally, the invention provides systems and methods for content proxying.

FIG. 24 depicts an architecture for content proxying. Content proxying allows for the aggregation of external content into the system pipeline. A proxy engine within a proxy server can act to collect and combine content from multiple sources (other servers) and transfer it to the holographic device 101 for viewing. For example, consider a proxy engine that receives content from two different CDNs wherein one CDN server contains content from the system and the other CDN server contains content from CNN. The content proxying engine could combine the content from both the CDNs to create a new single content feed which it sends to the holographic device 101. The holographic device 101 would be unaware of the mixing of content and would not have to have any special software or components to display the content. The two (or more) content feeds that come into the proxy engine can be transcoded in real-time to create the output feed. A simple example of this would have the proxy engine add branded transparent layers to the CNN content feed to show the system logo on top of the CNN content feed and stream it to a particular holographic device 101. While this is a simple static example of combining content more elaborate combination is possible. For example the system content that is combined with the CNN feed could include an overlaid set of menus such that the user could watch the CNN content, but then have overlaid interactive the system menus which allow the user to change the content coming from the CNN CDN server. The proxy engine would receive these commands and then request the appropriate content from the CNN CDN server make the switch.

In certain embodiments, systems and methods of the invention implement a social communication engine. The disclosed server infrastructure may provide support for communications across all of a plurality of holographic devices 101. Since several holographic devices 101 may be installed at a particular venue, it is important to consider the social aspects of the experience provided to end-users.

FIG. 25 depicts a social a mechanism of implementing a social communication engine. Several users at different holographic devices 101 might select or vote or participate in similar content options and it may be beneficial to have mechanisms in place to modify or alter the content itself based on this social user input. This could be implemented by using a trigger that is enabled when a threshold number of users complete some task such as voting. As such the social communications engine supports the aggregation of mobile gateway commands and local sensor commands into the system.

These commands may be acted on by pre-defined rules or scripts created by the customer leasing or owning the holographic devices 101. The said pre-defined rules or scripts would take the received commands and create a new series of commands and perhaps modified content to be broadcast back to the holographic devices 101 registered into a social communication session.

In some embodiments, systems support situations in which users accessing different holographic devices 101 at different locations may elect to vote on content options and the majority will decide the next content to be displayed on each holographic device 101. However, unlike interaction where each user at each device must be queued before interacting the voting can be much simpler where multiple users at each device could vote at the same time without waiting in a queue. The system may support a scenario in which there is direct communication or direct interaction between users at two different holographic devices 101. So for example a user at a first holographic device 101 can battle a user at a second holographic device 101 via the social communication engine, which will synchronize commands between the different users. The social communication engine provides a communication and data bridge between all holographic devices 101 registered in a certain group.

Systems and methods of the invention provide beneficial approaches to dynamic branding. Dynamic branding may involve deploying and re-deploying various ones of holographic device 101 to promote specific customer brands, and aligning those brand promotions in real-time with extrinsic events (e.g., showing a soft drink promotion before a crowd enters a movie and promoting a movie sequel as a crowd exits a movie).

FIG. 26 illustrates use of a system for dynamic branding. The dynamic branding module enables rebranding of both the holographic device 101 graphical layers and content sources as well as the interface of mobile app 427 itself. The control of the branding occurs at the server level and holographic devices 101 follow the server's lead. The server model responsible for the branding has access to information from each holographic device 101 including client ID, date, time of day, and currently accessing user. The server module uses this information to determine and fetch the proper branding elements for a specific holographic device 101 at a specific location and time; the associated mobile app information for users registered at that specific holographic device 101 is also fetched and made ready.

Both the holographic devices 101 and mobile apps poll the server at intervals to switch branding based on what the server module has established as the proper current branding for that instant. This allows each holographic device 101 to be leased to different companies at different times, so for example one holographic device 101 could be leased to company 1 in the morning, company 2 in the afternoon and company 3 in the evening. So when the time for company 1 is over the branding is immediately switched to the branding for company 2 and an approaching user would immediately see the switch to company 2 branding. The timing of the branding changes can be very precise and can change as often as desired so that companies can purchase branding spots on holographic devices 101. As an example consider a sporting event at a stadium which contains holographic devices 101. The stadium could rent the holographic device 101 to promote a soft drink during the first half of the match and to promote a retailer firm during the second half; hence maximizing revenues.

In some embodiments, systems of the invention employ data management modules. The data management modules provide support to gather, analyze, mine and visualize data. The data management modules gather data from holographic devices 101 or groups of holographic devices 101. The data is clustered according to the topology of the groups or all together or according to other rules set by the customer(s). For example, the data could be clustered according to time or keywords or user behaviors.

FIG. 27 illustrates a system employed for data management. The data gathering module provides support to gather and store this data at the server level. The data-mining module use machine learning algorithms to identify patterns in the data while the data visualization and reporting module format those results into intelligible visualizations and reports for the customer to consume. The data-mining can look for many interesting patterns depending on what the customer wishes to look for. Some common data-mining approaches include cluster analysis, anomaly detection, dependency detection, or a combination thereof. These approaches may be implemented using systems and methods of the invention.

In certain embodiments, registration includes a facial recognition operation. Holographic poster 101 may include a camera and a software module for facial recognition. Alternatively or additionally, a camera on a mobile device may be used. Servers 409 may execute a facial recognition procedure. Facial recognition allows poster 101 to associate the presence of a person with accessible digital data related to that person. For example, a user who has previously registered or who has generated an allowance for access to information in a social media account or profile by be photographed by a camera. A facial recognition module can associate that person with their account and retrieve information from the account or based on what is in the account. Additionally, facial recognition modules may be used to create digital inferences about a disposition of the user (e.g., a vector of variables output by a facial recognition algorithm can be used to select a category representing an inference about the user's present disposition where categories could include, for example, excited, pleased, bored, inattentive, distracted, active, or the vector could resolve categories relating to other features such as demographics). Facial recognition adds security controls where, for example, young people are not shown previews for R-rated movies. Facial recognition is known in the art and is described, for example, in U.S. Pat. No. 8,411,909; U.S. Pat. No. 8,406,484; U.S. Pat. No. 7,203,346; U.S. Pub. 2013/0121540; U.S. Pub. 2012/0288165; U.S. Pub. 2012/0278176; and U.S. Pub. 2012/0235790, the contents of each of which are incorporated by reference.

The invention provides systems and methods that include augmented reality functionality implemented on server-side software to accomplish tasks described herein more effectively than prior art communication. Augmented reality (AR) includes systems and methods that include a live, direct or indirect, view of a physical, real-world environment whose elements are augmented by computer-generated sensory input such as sound, light projection, facial recognition, mimicry, video, graphics or GPS data. Exemplary systems and methods including augmented reality that may be modified for use with the invention are described in U.S. Pat. No. 8,840,548; U.S. Pat. No. 8,275,414; U.S. Pub. 2013/0124326; U.S. Pub. 2013/0010068; U.S. Pub. 2012/0242865; U.S. Pub. 2012/0167135; and U.S. Pub. 2009/0061901, the contents of each of which are incorporated by reference. Examples of AR functions include using a server to cause a smartphone to act a world-viewer that reproduces the view that would be seen through the phone onto the screen of the phone and adds informational elements from a computer system. Another example of an AR functionality includes facial recognition by a server with data from a camera at or proximal to a poster 101 and providing a holographic display that address a user with personalized information (e.g., a 3D image of a sword-fighter appears and speakers play, “Hi John, use your smartphone as a sword and best me in fencing to receive a free soda before going into the theater to watch Swordmasters!” In certain embodiments, holographic poster 101 will use material from an augmented reality module on a server 409. Augmented reality allows for the display of digital information superimposed on top of a live video feed where the displayed information is related to the content in the video. Information processed by an augmented reality module on server 409 may be transmitted to cause a user to see some form of branded icons or thumbnails superimposed on displays of poster 101 or device 425. For example, if the user chooses to select an icon for specific holographic poster 101 shown on the screen of mobile device 425, then they might see the current content being displayed on the said holographic poster 101. Based on processing performed by servers 409, the user could then zoom into the holographic poster 101 and see if this content is of interest to them. Selecting the icon of a holographic poster 101 would lead to a map with instructions on how to reach this specific holographic poster 101. The directions could appear in a standard 2D map view or they may appear within the augmented reality display with the directions appearing within the live video as the user points the phone in different directions.

In some embodiments, mobile app 427 can be used to search for a poster 101 and aid the user in finding the poster by implementing augmented reality features provided by server 409. The search for a holographic poster 101 via a custom augmented reality procedure may involve an augmented reality module within mobile app 427, on the server side, or both. This module is responsible for querying a server database that contains the location data for all the holographic poster 101. This location data could be a latitude/longitude GPS coordinate or a series of custom SSID-identified labels from which basic location information can be extracted (usually mapping to static latitude/longitude coordinates). Once the server is queried for this location information, the server may send back a series of available holographic poster 101 nearby.

The invention provides devices and methods for displaying holographic content that is influenced by the motions of a user. A user may initiate, control, or interact with a holographic display and thus feel personally engaged and interested in the contents and progress of the display. Preferably, a holographic display device includes a sensor system configured to detect a motion and output data describing the motion, a computer device with a processor and coupled to the sensor system and operable to receive the data and render a hologram that is influence by the motion, and a holographic projection system coupled to the computer device and operable to display the hologram that is influenced by the motion. It may be found that the device provides benefits that are uniquely well-suited to crowded public entertainment venues such as the lobbies of movie theaters or areas surrounding a sports arena. The devices may be well suited to numerous short interactions with numerous different passerby and complement the positive, receptive mood exhibited by people seeking entertainment. This complementary aspect of setting may increase the effectiveness of communication performed by a device, engaging more people not only because of the sheer number of people present but also because the interactive, user-controlled nature of the provided holographic experience works uniquely well with movie and sports audiences.

FIG. 28 describes data flow to holographic device 101. The rendering of holographic content is defined by a meta renderer 905 which provides a stream of rendering elements to be rendered by the renderer 909. Renderer 909 may include any suitable rendering engine such as, for example, the game engine sold under the name UNITY by Unity Technologies (San Francisco, Calif.). Meta renderer 905 may exist as a script run by renderer 909 and may be implemented in Mono C# or JavaScript. This series of scripts run by renderer 909 may accept commands from the interactions gateway which itself streams data, commands, or both from both the mobile gateway 917 and sensors gateway 925. These scripts may also have access to a configuration file 901, which describes what data sources should be used to render the animated content at standard frame rates.

For example, a particular client will configure their holographic device 101 to display an animated glass of brandy. As part of the configuration, this client will also access current football match data in real-time and create a transparent layer to be displayed on top of the brandy glass animation. However only the glass of brandy animation will be altered in real-time by end users moving it around via the array of sensors (such as hand, arm, or body sensors) on the holographic device 101 itself. So renderer 909 always accepts commands from the interactions gateway as well as dynamic data sources 913 and multiplex this into a final rendered frame (which basically renders all dynamic transparent layers as well as the main animations/geometry provided by the customer leasing the holographic device 101).

There are a number of interaction and sensor mechanisms that may be included in sensor system 149 or used for part of an interactive holographic experience. They cover different aspects of the interaction of a person with holographic content. Interacting with a holographic device 101 may happen at different levels depending on the type of holographic device 101, the size of the device, and the capabilities of the devices with respect to embedded components. Also, the capacities of the person interacting with device 101 play a role depending on whether this person has or does not have access to a mobile device 425 or interaction device (such as joystick or remote control).

The interactions can be loosely grouped into different areas: basic sensors, advanced sensors to correlate user gestures to holographic objects, facial recognition and integration with holographic objects, interactions with multiple participants and interactions with multiple holographic devices 101.

Systems and methods of the invention provide for correlation of spatial gesture coordinates to coordinates of internal holographic objects. The described mechanisms may correlate or translate spatial coordinates (and the gestures performed therein) from one or more sensors in sensor system 149 to the coordinates of the objects within the 3D rendering context of a holographic display. This mechanism describes two coordinates systems wherein one is defined by a cubic area formed by motion sensors and another by the actual cubic size of the holographic projection from the holographic device 101. The two coordinate systems are mapped to each other such that motion and gestures of a hand (or other object) within the sensor region can be translated into motion and gestures of a virtual hand (or other object) within the holographic region. This mapping of the two coordinate systems allows for the description of how a holographic object can be translated, rotated, zoomed, pushed, pulled or otherwise moved. The gestures within the sensor area directly affects the content displayed within the holographic device 101 display area.

FIG. 29 illustrates how a user interacts with the sensor box and sees virtual hand in the holograph. A person's hands can be used to displace objects that are within the holographic projection. This occurs through the use of sensors in sensor system 149 that sense the hand movements and re-create a virtual hand within the 3D context of the holographic projection. The result of this is that the user, by placing their hands within the sensors area will see their “virtual” CGI hands immersed in the holographic projection and will be able to move objects around by virtually touching and pushing those objects. The sensors can be any sensor technology capable of tracking the movements of a human hand. For example infra-red sensors (such as those used in the Kinect) can be used to map out an area where hand motion can be captured. Visible light marker-less computer vision systems exist that can extract the human form from real-time video. Data from the sensors is captured in real-time and a software module is used to analyze the data. The analysis may do at least three things. First, the software may detect a structure such as a hand. The software preferably detects the orientation and configuration of the hand (relative position of all the fingers, palm and thumb) in order for the user to be able to handle an object. Once the hand orientation and configuration is found, the software tracks the motion of the hand in the received data. The tracked motion includes the orientation of the hand, the configuration of the fingers and the translational movement of the entire hand structure. There can be three degrees of freedom for translation, three for rotation, and essentially unlimited degrees of freedom for the hand configuration depending on the skeletal structure of the virtual hand.

FIG. 30 depicts hand configuration, orientation, and translation. The motion and orientation is extracted into a stream of data, which is used to as an input to a module that creates a holographic hand. This module maps the stream of data onto the movement, orientation and configuration of a holographic hand. This mapped data is then put through a rendering module which creates the final rendered hand movement in the holographic display. For better tracking of the movement of the user's hand, the sensor input can also optionally find and track the absolute spatial location of the hand, although tracking the movement of the hand can work in relative coordinates. In mapping the movement of the user's hand to the movement of the virtual hand there could be a scaling applied to the movement based on the relative size difference of the real and virtual hands. For example, the sensor region might be twice as big as the display region and the distance moved by the user's hand might be reduced by 50% so that the movement of the virtual hand in the display matches the relative movement of the user's hand in the sensor region.

FIG. 31 illustrates a process flow for the mapping of user's hand to the virtual hand. Another embodiment of the present mechanism uses a camera filming the hands or other sensor within the sensor area to create a video stream. The video stream is layered within the holographic projection of the holographic device 101. With this mechanism, the user would see a more realistic version of their own hand directly immersed within the holographic projection. Because the overlaid video is of their own hand, the user would recognize specific features of their own hand such as rings, nail polish, or tattoos, thus adding to the realism. This provides the user with a visual cue as to where they can interact with objects within the holographic projection without directly interacting with the holographic device itself but through a cubic area of sensors that represent an interactive proxy region through which the user may control the content of the holographic projection.

In some embodiments, sensor system 149 on holographic device 101 employs 360 degree, or panoramic, sensors. Panoramic sensors allow multiple users to interact with a circular or quad views-based projection system. The invention provides system and methods for controlling (e.g., rotating, translating, zooming, pushing, pulling or otherwise moving) virtual graphical objects (static or animated) being displayed inside a circular holographic (full 360 degrees viewable hologram) or surface based display (mirror based projection based hologram). Multiple separate sensors may be used to capture the gestures of multiple participants within close proximity and map those gestures onto multiple virtual objects in a holographic display. This allows a system to map multiple (e.g., 1-4 or more) users around a table and thus provides the necessary mechanisms for a full multiple participant holographic experience. The invention provides the sensor array and the mechanism by which the actions of the multiple participants may be captured and synchronized to the animated experience.

For panoramic sensors, any suitable array of sensors may be included. For example, a sensor array may include a single sensor area with multiple sensors, or an array may include a separate sensor area for each participant.

FIG. 32 illustrates a single sensor region with multiple participants. In the illustrated embodiment, the sensor array includes one large sensor area that is covered by multiple sensors whose sensing regions overlap. The large sensing region allows for multiple users to interact with this region at the same time. The gestures from all users are captured simultaneously. This type of sensor area could be implemented on a table where the participants surround the table. The participants within this large sensor area preferably have some distance between them so that their hands don't overlap. There could be markings on the table that outline sections for each participant to avoid overlapping of their movements. The data from the sensors would feed into a hand detection and tracking module. This module would work in real-time to track the movements of each participant. The software within the module distinguishes and tracks multiple distinct hands in the sensor data.

FIG. 33 illustrates an alternative embodiment, in which a sensor array includes multiple separate sensors with separate sensing regions with one sensing region for each participant. The separate sensing regions could be adjacent to each other but separated by a divider, which could block the sensor in one region from sensing movement in any adjacent region. This could be implemented with all regions on the same table. In certain embodiments, the total area of the holographic display region is represented by the sum of the areas of each sensor region so that each sensor region covers a part of the holographic region. Since each region is distinct, this arrangement avoids any issues with directly interacting or overlapping virtual hands. Each participant would have a sensor region that corresponds to a region of the holographic display of similar size and shape. The user's movements within their sensor region would limit the movement of their virtual hand within the corresponding holographic region.

FIG. 34 outlines steps for hand movement tracking and conversion into virtual hand movement. Regardless of the type of sensor array used, the motions and gestures of each user's hand would be transferred to the movement of virtual hands within a single holographic region. Preferably, there is at least one virtual hand for each participant. The interaction of virtual hands with objects can be handled in several different ways. In one embodiment, multiple participants interact with the same holographic object. The different users may interact with the same object, but by interacting with different aspects of the object. For example, one user would be able to laterally move the object, while another would be able to rotate it, and while still another would be able to change the size of the displayed hologram. In another aspect of that embodiment the different users would interact with the same aspect of the holographic object; so for example all users would be attempting to move the same object. Thus the different users could be fighting against each other to try to move the same object.

Systems and methods of the invention can implement any suitable rules to interpret the input from each user and transform that input into the movement of the holographic hand of the user. For example, speed can represent the force of the hand pushing on the holographic object such that the fastest user would have the most forceful holographic hand. Alternatively or additionally, an object could have multiple elements such that participant can interact with a different element. For example consider a holographic object that has many components (buttons, levers, knobs, or anything a participant can interact with). The different users could interact with the different components all at the same time; for example user 1 would push button 3 and user 2 would push button 5. In related embodiments, each user interacts with a completely different aspect of the holographic display at the same time. For example, the first person to touch an object within the holographic display gets control of that object until they let it go. Other users would be blocked from interaction with this specific object while it was being used. There could be a simple visual notification that an object is being used and therefore locked by a user. For example, the object would glow a specific color (e.g., with users each assigned a color) or alternatively it would have a small flag associated with a user.

In certain embodiments, registration includes a facial recognition operation. Holographic poster 101 may include a camera 157 and a software module for facial recognition. Alternatively or additionally, a camera on a mobile device may be used. Servers 409 or processors in device 101 may execute a facial recognition procedure. Facial recognition allows poster 101 to associate the presence or features of a person with accessible digital data related to that person. For example, a user who has previously registered or who has generated an allowance for access to information in a social media account or profile may be photographed by a camera. A facial recognition module can associate that person with their account and retrieve information from the account or based on what is in the account. Additionally, facial recognition modules may be used to create digital inferences about a disposition of the user (e.g., a vector of variables output by a facial recognition algorithm can be used to select a category representing an inference about the user's present disposition where categories could include, for example, excited, pleased, bored, inattentive, distracted, active, or the vector could resolve categories relating to other features such as demographics). Facial recognition adds security controls where, for example, young people are not shown previews for R-rated movies. Facial recognition is known in the art and is described, for example, in U.S. Pat. No. 8,411,909; U.S. Pat. No. 8,406,484; U.S. Pat. No. 7,203,346; U.S. Pub. 2013/0121540; U.S. Pub. 2012/0288165; U.S. Pub. 2012/0278176; and U.S. Pub. 2012/0235790, the contents of each of which are incorporated by reference.

In some embodiments, the invention provides systems and methods for using a facial recognition procedure and mapping detected data to a holographic character. Camera 157 may include a z-depth camera as discussed elsewhere herein and may be used to recognize facial expressions of a user and provide reactive behavior within the holographic virtual animated character or object. One-to-one mapping of the emotions are possible. Detected features may be mapped to human emotions. For example, a smile may be mapped to pleasure or fidgets may be mapped to inattention. The mapped emotions may, in turn, be mapped to the actions of a holographic object or character.

FIG. 35 shows facial expression mapping to holographic animation. The facial expressions analysis is known in the art and may use machine learning techniques to learn from a training phase how to map the emotions from known facial expressions to an analysis of the geometry of a face. The training phase may include analyzing a plurality of facial images from a database and mapping the results of the analysis to the known emotions shown in the images. The output of the facial expressions analysis would be used to translate the analyzed expressions into corresponding branded selected expressions in a hologram.

FIG. 36 diagrams a method of using facial recognition and mapping to trigger branding. With this mechanism the facial emotion of a human user that approaches a holographic device 101 can be used to trigger brand-specific actions in the holographic device 101. In order to accomplish this, a customer promoting a brand may select a virtual 3D character (or object) and builds a configuration grid of basic expressions that would be mapped or translated into corresponding 3D animations on the virtual character. The 3D animations on the virtual character do not have to match the actions in the facial expressions. For example, if the human user is smiling this does not necessarily mean that the animated character will be smiling. Rather, the emotion of ‘smiling’ maps to the action ‘X’ on the holographic character, where ‘X’ could represent jumping, or smiling, or waving or any other action that can be shown by a hologram. So a user could smile and it would trigger a push-up animation on the virtual character. The target action done by the virtual character can be made brand-specific, so that with a different brand the same smile could be mapped to a jump and turn animation. The links between the virtual character reactions and the analyzed expressions of a user are preferably dynamically reconfigurable. This can be accomplished by providing independent modules for different operations. Under this architecture, the facial recognition operation, the mapping operation, and the brand choice operation each involve a software module that can be updated independently of the others. This way, a device 101 has the benefit that the facial expression learning algorithm can be worked or improved, the customer's branding information can be changed or updated, and the content selection logic can be replaced, each independently.

In some embodiments, the software modules mapping the facial analysis to a set of emotions will be constant after the training phase is complete. However the brand-specific grid of animated reactions that those emotions map to may be dynamic, in the sense that the animated reactions can be changed at any time.

In certain embodiments, the invention provides systems and methods for analyzing behaviors of approaching users and providing reactive behaviors based on the analyzed approaching user behaviors. Sensor system 149 may capture the movements, walking speed, arm gestures, general behavior, other aspects of the user, or a combination thereof and trigger animated 3D reactions within the holographic character or trigger new content to be displayed. This mechanism would work on a holographic device 101 equipped with a sensor such as a z-focus camera, or an infra-red detection system (similar to the Kinect system) that is capable of capturing the motion, gestures, and posture of individuals that pass in close proximity to the holographic device 101. The individuals that pass the holographic device 101 do not need to be registered or to have a mobile device in order to interact with the device, they may simply pass near the device and be captured by the devices sensors. Data from the sensors would be analyzed in real-time to extract the motion and gestures of nearby users. These motions and gestures would then be analyzed to extract some form of meaning or emotion. This extracted meaning, or emotion, would then be used to trigger an action in the holographic display for the individual to see. Thus, the invention provides systems and methods for detecting an approach of one or more people to a holographic device, sensing an aspect of the one or more people, and associating the sensed aspect with a category. The category can be used to select stored content or deliver rendered content. For example, children may approach the holographic device 101. The sensors would sense aspects such as their small stature and their fast and chaotic movements and associate the sensed aspects with a category for children. The holographic device 101 would then display content appropriate for children such as a preview for an animated movie. Or, as another example, consider a loving couple approaching the device holding hands and walking close to each other. The sensors may sense aspects such as hand-holding, dilated pupils, public displays of affection and associate the sensed aspects with a category for affectionate couple. The system could then play or render content that is associated with the affectionate couple category, such as a nice holographic bottle of wine and some flowers along with promotions for a romantic movie.

FIG. 37 gives a process for linking user motions with holographic actions. The described systems and methods can be employed to create a map of actions-to-reactions from the physical user to the hologram itself. This mechanism could include the aspect of rental periods such that the specific reactions of the hologram would be dependent upon the company that is renting the holographic device 101 at any given moment.

Aspects of the invention provide systems and methods for a multi-part experience among a plurality of holographic devices. A user may travel from a first holographic device 101 to another holographic device 101 and a single coherent experience may be maintained throughout by systems and methods of the invention. For example, where a sports arena has a series of device 101 installed at about 30 foot intervals between a gate and a concession stand, servers 409 can use motion data from sensor system 149 to determine a present average speed of passing foot traffic and synchronize content so that passerby experience an uninterrupted narrative in the holographic content. In other embodiments, devices 101 provide a complex interactive experience, such as a multi-station game. Systems of the invention are used to complete parts of the interactive experience. The plurality of devices 101 communicate with each other to contextualize the interacting user as the user moves between devices. Thus a system of the invention is operable to register a user and receive interactions between the user and a first holographic device 101 and also between the user and a second holographic device 101 while coordinating the content delivery between the two devices. In some embodiments, the user disengages with the first holographic device 101 and searches for or travels to the second device 101. In certain embodiments, disengaging involves the user walking away from a device and being automatically disconnected. Alternatively, the user may specifically choose to continue elsewhere by selecting a menu option for ‘Move to another device’. There can be a time limit option where users only have a certain amount of time to reach the next device before their session officially ends. Preferably, the user finds, approaches and is ‘recognized’ by the second holographic device 101.

After recognizing the user, second device 101 determines that the user had been interacting with first device 101. This information might be stored on the user's mobile device, or it might be held on server 409. In some embodiments, second device 101 contacts first device 101 to request information about the user, including information about their last session at first device 101. This can be done via servers 409 which store previous session information for a given user. Additionally or alternatively, this can be done by direct device-to-device communication via Wi-Fi, WAN, LAN, or similar connection. Once the communication is established, second device 101 downloads the necessary info from first device 101 or from servers 409. Once second device 101 has the user's previous session information in its local memory, it loads the information and begins a new session and the user continues interacting on second device 101.

Embodiments of the invention include a rendering system to provide holographic content.

FIG. 38 illustrates a rendering system. The rendering process may provide core functionality of the content assembly and delivery to one or more holographic devices 101. When the rendering happens in the cloud or on servers 409, there might be several running instances of the renderer 909 on one single machine (or cloud instance). Preferably, each rendering instance serves a holographic device 101. Each rendering instance is configured to render content based on the currently leased holographic device 101 which will involve a specific user experience to be delivered to the holographic device 101. Occasionally this experience will be passive and consist of a simple video with no user interaction and at other times it will be full 3D content with user interaction. Each rendering instance loads the holographic device 101 configuration file for a specific period of time during the day and starts rendering using this information. The rendered output is sent to the holographic device 101 using suitable methods. Each rendering instance accepts all incoming data channels (interactions, feeds, custom data channels) and alters the basic programmed holographic device 101 content by re-rendering each frame at standard frame rates (typically 30/FPS).

The rendering process may be linked to sensor system 149 to embody interactions as described herein. Preferably, device 101 includes sensor processing modules within the rendering engine (scripts) or as fast bandwidth data pipes between the rendering engine and the sensors process themselves. The rendering process takes external input from sensors as well as dynamic data sources and generates a final stream of video to be displayed on holographic device 101.

Using computing systems as described herein and embodied in device 101, servers 409, or a combination thereof, various useful communication functions can be performed. In certain embodiments, the invention provides systems and methods that include augmented reality functionality to accomplish tasks described herein.

Augmented reality (AR) includes systems and methods that include a live, direct or indirect, view of a physical, real-world environment whose elements are augmented by computer-generated sensory input such as sound, light projection, facial recognition, mimicry, video, graphics or GPS data. Exemplary systems and methods including augmented reality that may be modified for use with the invention are described in U.S. Pat. No. 8,840,548; U.S. Pat. No. 8,275,414; U.S. Pub. 2013/0124326; U.S. Pub. 2013/0010068; U.S. Pub. 2012/0242865; U.S. Pub. 2012/0167135; and U.S. Pub. 2009/0061901, the contents of each of which are incorporated by reference. Examples of AR functions include causing a smartphone to act a world-viewer that reproduces the view that would be seen through the phone onto the screen of the phone and adds informational elements from a computer system. Another example of an AR functionality includes facial recognition with data from camera 157 and providing a holographic display that address a user with personalized information (e.g., a 3D image of a sword-fighter appears and speakers play, “Hi John, use your smartphone as a sword and best me in fencing to receive a free soda before going into the theater to watch Swordmasters!” In certain embodiments, holographic poster 101 will use material from an augmented reality module. Augmented reality allows for the display of digital information superimposed on top of a live video feed where the displayed information is related to the content in the video. Information processed by an augmented reality module may be displayed to cause a user to see some form of branded icons or thumbnails superimposed on displays of poster 101 or device 425. For example, if the user chooses to select an icon for specific holographic poster 101 shown on the screen of mobile device 425, then they might see the current content being displayed on holographic poster 101. A user could then zoom into the holographic poster 101 and see if this content is of interest to them. Selecting the icon of a holographic poster 101 would lead to a map with instructions on how to reach this specific holographic poster 101. The directions could appear in a standard 2D map view or they may appear within the augmented reality display with the directions appearing within the live video as the user points the phone in different directions.

In some embodiments, mobile app 427 can be used to search for a poster 101 and aid the user in finding the poster by implementing augmented reality features provided by server 409. The search for a holographic poster 101 via a custom augmented reality procedure may involve an augmented reality module within mobile app 427, on the server side, or both. This module is responsible for querying a server database that contains the location data for all the holographic posters 101. This location data could be a latitude/longitude GPS coordinate or a series of custom SSID-identified labels from which basic location information can be extracted (usually mapping to static latitude/longitude coordinates). Once the server is queried for this location information, the server may send back a series of available holographic poster 101 nearby.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A holographic poster device comprising:
a body comprising a pedestal configured to sit on a floor;
a display area supported by the body at a top of the pedestal, wherein the display area comprises an electronic display source and a visible display area, wherein the visible display area comprises a panel of at least partially reflective material disposed above the electronic display source at an angle with respect to the horizontal;
a computer system carried by the body and comprising a processor coupled to a non-transitory memory, the computer system operable to make a holographic image appear in the display area.

2. The device of claim 1, wherein the reflective material comprises a beam splitter and the angle is between 35° and 65°.

3. The device of claim 2, further comprising a network connection device.

4. The device of claim 3, wherein the computing device is operable to stream images from a distal source while receiving a signal through the network connection device and display images from the memory while not receiving a signal through the network connection device.

5. The device of claim 4, wherein the pedestal supports the display area at least a few feet above the floor.

6. The device of claim 5, further comprising a local wireless connection mechanism.

7. The device of claim 6, wherein the local wireless connection mechanism is configured to exchange information with a handheld apparatus that comes within a few feet of the device.

8. The device of claim 7, further comprising a camera and wherein the computer system is operable to perform z buffering operations on data received via the camera.

9. The device of claim 8, wherein the computer system comprises an integrated graphics chipset on a motherboard.

10. The device of claim 8, wherein the computer system comprises a graphics card comprising a RAM chip and a graphics processing unit.

11. A holographic poster comprising:
a pedestal to sit on a floor;
a beam splitter supported at the top of the pedestal at least four feet above the floor and disposed at an angle to the horizontal;
an image source concealed from the view of a person standing near the poster and configured to cast an image onto the beam splitter; and
a computer system comprising a processor coupled to a memory device and housed within the pedestal, the computer system coupled to the image source to provide display content.

12. The poster of claim 11, wherein the computer device is operable to receive the display content from a server computer and store the display content in memory therein.

13. The poster of claim 11, wherein the computer device is operable to exchange information with a mobile device nearby and control the display content according to user input received via the mobile device.

14. The poster of claim 11, further comprising a motion sensor to detect motion within a few feet of the device.

15. The poster of claim 14, wherein the computer device causes the display content to form a holographic video mimicking the detected motion.

16. A holographic display delivery system comprising:
a server computer comprising a processor coupled to a non-transitory memory having stored therein digital media formatted for display as a 3D hologram and instructions executable by the processor to cause the system to:
connect to a remote holographic display device;
transmit the digital media to the holographic display device; and
cause the holographic display device to display the digital media.

17. The system of claim 16, further operable to receive additional media and use a queue to cause the holographic display device to display the digital media and the additional media at specified times.

18. The system of claim 17, wherein the queue comprises times of one selected from the list consisting of sporting events and movie screenings.

19. The system of claim 18, further operable to cause a plurality of holographic display devices to display the content.

20. The system of claim 19, further operable to receive an input from a user's use of a mobile device and to control the display of the holographic content according to the input.
